(19) United States
(12) Patent Application Publication
(10) Pub. No.: US 2023/0353695 A1
(43) Pub. Date: Nov. 2, 2023

(54) INFORMATION PROCESSING APPARATUS, METHOD, AND NON-TRANSITORY COMPUTER-READABLE STORAGE MEDIUM STORING PROGRAM

(71) Applicant: CANON KABUSHIKI KAISHA, Tokyo (JP)

(72) Inventor: Chisei SUMITA, Tokyo (JP)

(21) Appl. No.: 18/303,928

(22) Filed: Apr. 20, 2023

(30) Foreign Application Priority Data
Apr. 28, 2022 (JP) 2022-075411

(51) Int. Cl. H04N 1/327; H04W 76/14; H04N 1/00; H04W 4/80

(52) U.S. Cl. CPC H04N 1/32776; H04W 76/14; H04N 1/00427; H04W 4/80

(57) ABSTRACT

A method includes: acquiring information of a communication apparatus from the communication apparatus capable of wirelessly communicating with an information processing apparatus; displaying, on a display unit, a selection screen for a setting concerning connection between the communication apparatus and a device outside the communication apparatus, based on the acquired information of the communication apparatus; and performing processing according to a selection result on the selection screen. The selection screen is a screen on which a plurality of connection methods for the setting are selectably displayed, and the plurality of connection methods include a first connection method for connecting an access point outside the communication apparatus to the communication apparatus, and a second connection method for connecting, without the access point, the information processing apparatus to the communication apparatus.

### BACKGROUND OF THE INVENTION

### Field of the Invention

The present invention relates to an information processing apparatus that performs setting concerning connection between apparatuses, a method, and a non-transitory computer-readable storage medium storing a program.

### Description of the Related Art

There is known a technique of transmitting information about an access point from an information processing apparatus such as a Personal Computer (PC) to a communication apparatus such as a printer, thereby connecting the communication apparatus to an external apparatus. Japanese Patent Laid-Open No. 2019-180038 describes displaying a connection method selection screen on a printer side.

### SUMMARY OF THE INVENTION

The present invention provides an information processing apparatus that improves convenience in setting concerning connection of a printer, a method, and a non-transitory computer-readable storage medium storing a program.

The present invention in one aspect provides a method comprising: acquiring information of a communication apparatus from the communication apparatus capable of wirelessly communicating with an information processing apparatus; displaying, on a display unit, a selection screen for a setting concerning connection between the communication apparatus and a device outside the communication apparatus, based on the acquired information of the communication apparatus; and performing processing according to a selection result on the selection screen, wherein the selection screen is a screen on which a plurality of connection methods for the setting are selectably displayed, and the plurality of connection methods include a first connection method for connecting an access point outside the communication apparatus to the communication apparatus, and a second connection method for connecting, without the access point, the information processing apparatus to the communication apparatus.

According to the present invention, it is possible to improve convenience in setting concerning connection of a printer.

Further features of the present invention will become apparent from the following description of exemplary embodiments with reference to the attached drawings.

### BRIEF DESCRIPTION OF THE DRAWINGS

FIG. 1 is a view showing the configurations of an information processing apparatus, a communication apparatus, and an access point;

FIG. 2 is a view showing the configuration of an NFC unit;

FIGS. 3A to 3C are sequences chart executed between the information processing apparatus and the communication apparatus;

FIG. 4 is a view showing a screen displayed on the information processing apparatus;

FIG. 5 is a flowchart showing processing executed by the information processing apparatus;

FIG. 6 is a flowchart showing processing executed by the information processing apparatus;

FIG. 7 is a flowchart showing processing executed by the information processing apparatus;

FIGS. 8A and 8B are views showing screens displayed on the information processing apparatus;

FIG. 9 is a flowchart showing processing executed by the communication apparatus;

FIG. 10 is a sequence chart executed between the information processing apparatus and the communication apparatus;

FIG. 11 is a view showing a WEC start screen;

FIG. 12 is a flowchart showing DPP waiting mode start processing;

FIG. 13 is a flowchart showing execution processing of WEC;

FIG. 14 is a view showing a screen displayed on the information processing apparatus;

FIG. 15 is a view showing a screen displayed on the information processing apparatus;

FIG. 16 is a view showing a screen displayed on the information processing apparatus;

FIG. 17 is a view showing a screen displayed on the information processing apparatus; and

FIG. 18 is a view showing a screen displayed on the information processing apparatus.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made an invention that requires all such features, and multiple such features may be combined as appropriate. Furthermore, in the attached drawings, the same reference numerals are given to the same or similar configurations, and redundant description thereof is omitted.

In Japanese Patent Laid-Open No. 2019-180038, after the connection method selection screen is displayed on the printer side, user intention confirmation about the connection method is accepted on a terminal side, and therefore, the user operation until selection determination is complex.

According to the present disclosure, it is possible to improve convenience in setting concerning connection of a printer.

An information processing apparatus and a communication apparatus included in a communication system according to this embodiment will be described. In this embodiment, a smartphone is exemplified as the information processing apparatus, but the present invention is not limited to this. For example, as the information processing apparatus, various kinds of apparatuses such as a portable terminal, a Personal Computer (PC), a tablet terminal, a Personal Digital Assistant (PDA), and a digital camera are applicable. In this embodiment, a printer is exemplified as the communication apparatus, but the present invention is not limited to this, and various kinds of apparatuses are applicable as long as they can perform wireless communication with the information processing apparatus. For example, concerning a printer, the present invention can be applied to an inkjet printer, a full-color laser beam printer, a monochrome printer, and the like. Furthermore, the present invention can be applied not only to a printer but also to a copying machine, a facsimile apparatus, a portable terminal, a smartphone, a laptop, a tablet terminal, a PDA, a digital camera, a music playback device, a television, a smart speaker, and the like. In addition, the present invention can be applied to a multi-function peripheral having a plurality of functions such as a copying function, a FAX function, and a print function.

In this embodiment, if the information processing apparatus supports a function called Wi-Fi Easy Connect® (to be referred to as WEC hereinafter), it can execute this function. WEC is a function of executing network setup of another apparatus using the Device Provisioning Protocol (to be referred to as DPP hereinafter) formulated by the Wi-Fi Alliance. Note that more specifically, network setup of another apparatus is processing of connecting another apparatus to an access point that forms a network. In WEC, communication is performed between a device (to be referred to as a Configurator device hereinafter) that operates as a “Configurator” and a device (to be referred to as an Enrollee device hereinafter) that operates as an “Enrollee”. The Configurator device acquires Bootstrapping information from the Enrollee device. The Bootstrapping information includes, for example, the identification information (for example, the MAC address) of the Enrollee device, public key information used to perform secure communication with the Enrollee device, and the like. In this embodiment, the Bootstrapping information will be described as “WEC associated information”. Note that other pieces of information can also be handled as WEC associated information. The Configurator device executes wireless communication with the Enrollee device using the acquired Bootstrapping information. More specifically, for example, the Configurator device encrypts a protocol key using a public key included in the Bootstrapping information, and transmits the encrypted protocol key to the Enrollee device. Then, the Configurator device then encrypts a common key based on the encrypted protocol key, and transmits information encrypted using the common key to the Enrollee device. Note that more specifically, the information transmitted here is, for example, connection information used to connect to an access point. Then, the Enrollee device establishes wireless communication with the access point using the connection information received from the Configurator device. Note that the description will be made assuming that in network setup processing by WEC according to this embodiment, an information processing apparatus supporting WEC operates as a Configurator device, and a communication apparatus supporting WEC operates as an Enrollee device.

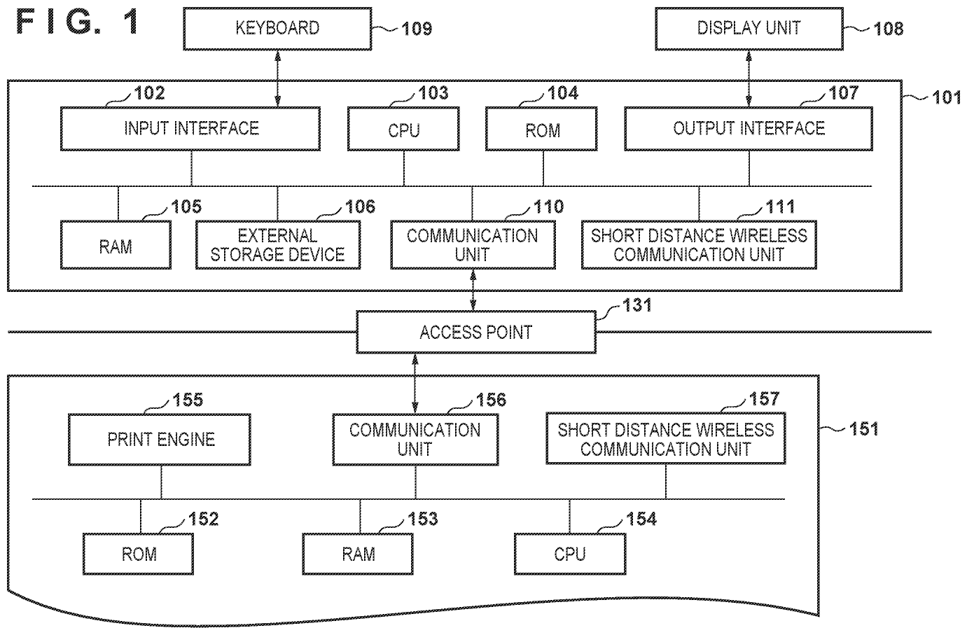

First, the configurations of an information processing apparatus of this embodiment and a communication apparatus communicable with the information processing apparatus of this embodiment will be described with reference to a block diagram shown in FIG. 1. In this embodiment, the following configurations will be described as an example. This embodiment can be applied to an apparatus capable of communicating with a communication apparatus, and the functions are not limited to those shown in FIG. 1.

An information processing apparatus 101 is an information processing apparatus according to this embodiment. The information processing apparatus 101 includes an input interface 102, a CPU 103, a ROM 104, a RAM 105, an external storage device 106, an output interface 107, a display unit 108, a communication unit 110, and a short distance wireless communication unit 111. The CPU 103, the ROM 104, the RAM 105, and the like form a computer of the information processing apparatus 101.

The input interface 102 is an interface for accepting data input and operation instructions from the user when an operation unit such as a keyboard 109 is operated. Note that the operation unit may include a physical keyboard and physical buttons, or may include a software keyboard and software buttons displayed on the display unit 108. That is, the input interface 102 may accept input from the user via the display unit 108.

The CPU 103 is a system control unit and controls the whole information processing apparatus 101.

The ROM 104 stores permanent data such as control programs to be executed by the CPU 103, data tables, and an embedded operating system (to be referred to as an OS hereinafter) program. In this embodiment, the control programs stored in the ROM 104 perform software execution control such as scheduling, task switch, and interrupt processing under the management of the embedded OS stored in the ROM 104.

The RAM 105 is formed by a Static Random Access Memory (SRAM) or the like, which needs a backup power supply. Note that the RAM 105 can store important data such as program control variables without volatilization because the data are held by a primary battery (not shown) for data backup. In addition, a memory area for storing setting information of the information processing apparatus 101, management data of the information processing apparatus 101, and the like is also provided in the RAM 105. Furthermore, the RAM 105 is also used as the main memory and the work memory of the CPU 103.

The external storage device 106 stores an application program (to be referred to as a setting application) configured to perform a network setup of the communication apparatus 151, a print information generation program that generates print information interpretable by the printing apparatus 151, and the like. The setting application is an application program for setting an access point as the connection destination of the communication apparatus 151 by WEC or the like. Note that the setting application may have functions other than the network setup function. For example, the setting application may have a function of causing the communication apparatus 151 to execute printing, a function of scanning a document set on the communication apparatus 151, a function of confirming the state of the communication apparatus 151, and the like. The setting application is stored in the external storage device 106 by being installed from an external server by, for example, Internet communication via the communication unit 110. Furthermore, the external storage device 106 stores various kinds of programs such as an information transmission/reception control program to be transmitted/received to/from the communication apparatus 151 connected via the communication unit 110, and various kinds of information to be used by the programs.

The output interface 107 is an interface that performs control to cause the display unit 108 to display data or notify the state of the information processing apparatus 101.

The display unit 108 is formed by a Light-Emitting Diode (LED), a Liquid Crystal Display (LCD), or the like and displays data or notifies the state of the information processing apparatus 101.

The communication unit 110 is a component connected to an apparatus such as the communication apparatus 151 or an access point 131 to execute data communication. For example, the communication unit 110 can be connected to an access point (not shown) in the communication apparatus 151. If the communication unit 110 and the access point in the communication apparatus 151 are connected, the information processing apparatus 101 and the communication apparatus 151 can communicate with each other. Note that the communication unit 110 may directly communicate with the communication apparatus 151 by wireless communication, or may perform communication via an external apparatus existing outside the information processing apparatus 101 and the communication apparatus 151. Note that examples of the external apparatus include an external access point (the access point 131 or the like) existing outside the information processing apparatus 101 and the communication apparatus 151, and an apparatus, other than the access point, that can relay communication. In this embodiment, as a wireless communication method used by the communication unit 110, Wireless Fidelity (Wi-Fi)® which is a communication standard based on the IEEE802.11 series is used. WEC described above is executed by communication by the communication unit 110. In addition, for example, a device such as a wireless LAN router is used as the access point 131. Note that in this embodiment, the method of directly connecting the information processing apparatus 101 and the communication apparatus 151 without intervention of an external access point is called a direct connection method. In addition, the method of connecting the information processing apparatus 101 and the communication apparatus 151 via the external access point is called an infrastructure connection method.

The short distance wireless communication unit 111 is a component wirelessly connected to the apparatus such as the communication apparatus 151 in a short distance to execute data communication, and performs communication by a communication method different from that of the communication unit 110. The short distance wireless communication unit 111 can be connected to a short distance wireless communication unit 157 in the communication apparatus 151. As the communication method, for example, Near Field Communication (NFC), Bluetooth® Classic, Bluetooth Low Energy (BLE), a Wi-Fi Aware, or the like is used.

In this embodiment, the information processing apparatus 101 executes WEC by its OS based on an exertion instruction of network setup processing by the setting application.

The communication apparatus 151 is a communication apparatus according to this embodiment. The communication apparatus 151 includes a ROM 152, a RAM 153, a CPU 154, a print engine 155, a communication unit 156, and the short distance wireless communication unit 157. The ROM 152, the RAM 153, the CPU 154, and the like form a computer of the communication apparatus 151.

The communication unit 156 includes, as the access point in the communication apparatus 151, an access point for connection to the external apparatus such as the information processing apparatus 101. Note that the access point can be connected to the communication unit 110 of the information processing apparatus 101. If the communication unit 156 enables the access point, the communication apparatus 151 operates as the access point. Note that the communication unit 156 may directly, wirelessly be connected to the information processing apparatus 101 or may wirelessly be connected to the information processing apparatus 101 via the access point 131. In this embodiment, as the wireless communication method used by the communication unit 156, a communication standard based on the IEEE802.11 series is used. Also, in the following explanation, Wi-Fi (WirelessFidelity)® is a communication standard based on the IEEE802.11 series. If the communication apparatus 151 supports WEC, WEC describe above is executed by communication by the communication unit 156. The communication unit 156 may include hardware functioning as an access point or may operate as an access point by software for functioning as an access point.

The communication apparatus 151 of this embodiment can operate in an infrastructure mode or a Peer-To-Peer (P2P) mode as a mode for performing communication using the communication unit 156.

The infrastructure mode is a mode in which the communication apparatus 151 communicates with another apparatus such as the information processing apparatus 101 via an external apparatus (for example, the access point 131) forming a network. Connection to the external access point, which is established by the communication apparatus 151 operating in the infrastructure mode, is called infrastructure connection hereinafter. In this embodiment, in the infrastructure connection, the communication apparatus 151 operates as a slave station and the external access point operates as a master station. Note that in this embodiment, the master station is an apparatus that decides a communication channel used in a network to which the master station belongs, and the slave station is an apparatus that does not decide a communication channel used in a network to which the slave station belongs, and uses the communication channel decided by the master station.

The P2P mode is a mode in which the communication apparatus 151 directly communicates with another apparatus such as the information processing apparatus 101 without intervention of an external apparatus forming a network. In this embodiment, the P2P mode includes an AP mode in which the communication apparatus 151 operates as an access point. In the AP mode, connection information (SSID and password) of the access point enabled in the communication apparatus 151 can arbitrarily be set by the user. Note that the P2P mode may include, for example, a WFD mode in which the communication apparatus 151 performs communication by Wi-Fi Direct (WFD). Note that which of a plurality of WFD-capable apparatuses operates as a master station is decided in accordance with, for example, the Group Owner Negotiation procedure. The master station may be decided without executing the Group Owner Negotiation procedure. An apparatus that is a WFD-capable apparatus and serves as a master station is especially called a Group Owner. Direct connection to another apparatus, which is established by the communication apparatus 151 operating in the P2P mode, is called direct connection. In this embodiment, in the direct connection, the communication apparatus 151 operates as a master station and the other apparatus operates as a slave station.

Furthermore, in this embodiment, the communication apparatus 151 can operate in a network setup mode as a mode of executing a network setup of the communication apparatus 151 by accepting a predetermined operation from the user. If the communication apparatus 151 operates in the network setup mode, it uses the communication unit 156 to operate as a setup access point which is enabled during the operation in the network setup mode. The setup access point is an access point different from an access point enabled in the above-described AP mode. Furthermore, the SSID of the setup access point includes a predetermined character string that can be recognized by the setting application of the information processing apparatus 101. The setup access point is an access point that does not require a password for connection. The communication apparatus 151 operating in the network setup mode uses a predetermined communication protocol (setup communication protocol) in communication with the information processing apparatus 101 connected to the setup access point. More specifically, the setup communication protocol is, for example, Simple Network Management Protocol (SNMP). If a predetermined time elapses after the start of the operation in the network setup mode, the communication apparatus 151 stops the operation in the network setup mode, and disables the setup access point. This is because the setup access point is an access point that does not require a password, as described above, and thus if the access point is enabled for a long time, an inappropriate apparatus highly probably requests connection. Note that the setup access point may be an access point that requires a password. In this case, a password used to connect to the setup access point is a fixed password (unchangeable by the user) that is grasped in advance by the setting application.

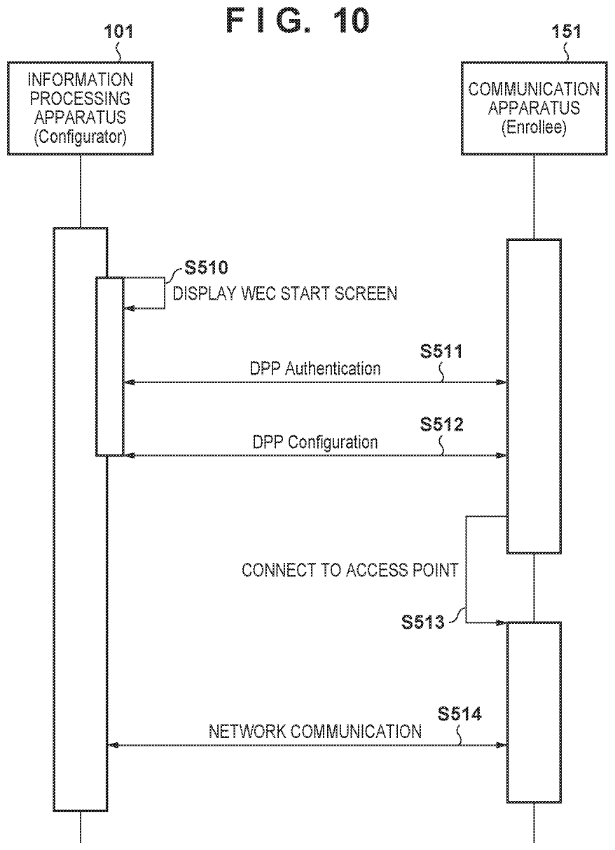

Also, in this embodiment, the communication apparatus 151 accepts a predetermined operation from the user, thereby operating in a mode for executing the network setup of the communication apparatus 151 using a communication protocol different from the setup communication protocol. In this embodiment, the communication protocol different from the setup communication protocol is the above-described DPP, and the mode is called a DPP waiting mode. Upon receiving a network setup request by DPP from the information processing apparatus 101 in a state in which the communication apparatus 151 is operating in the DPP waiting mode, the communication apparatus 151 executes network setup by DPP in a way to be described later. Hence, in other words, the DPP waiting mode is a mode for waiting for a network setup request by DPP. The DPP waiting mode will be described later with reference to FIGS. 10 and 12.

The short distance wireless communication unit 157 is a component wirelessly connected to the apparatus such as the information processing apparatus 101 in a short distance, and can be connected to, for example, the short distance wireless communication unit 111 in the information processing apparatus 101. As the communication method, for example, NFC, Bluetooth Classic, BLE, Wi-Fi Aware, or the like is used.

The RAM 153 is formed by an SRAM or the like, which needs a backup power supply. Note that the RAM 153 can store important data such as program control variables without volatilization because the data are held by a primary battery (not shown) for data backup. In addition, a memory area for storing setting information of the communication apparatus 151, management data of the communication apparatus 151, and the like is also provided in the RAM 153. Furthermore, the RAM 153 is used as the main memory and the work memory of the CPU 154, and functions as a reception buffer configured to temporarily store print information received from the information processing apparatus 101 or the like, or stores various kinds of information.

The ROM 152 stores permanent data such as control programs to be executed by the CPU 154, data tables, and an OS program. In this embodiment, the control programs stored in the ROM 152 perform software execution control such as scheduling, task switch, and interrupt processing under the management of the embedded OS stored in the ROM 152.

The CPU 154 is a system control unit and controls the whole communication apparatus 151.

Based on information stored in the RAM 153 or a print job received from the information processing apparatus 101 or the like, the print engine 155 forms an image on a print medium such as a paper sheet by applying a printing material such as ink onto the print medium, and outputs the print result. Note that in general, the data amount of the print job transmitted from the information processing apparatus 101 or the like is large, and thus it is necessary to use, for communication of the print job, a communication method that allows high-speed communication. Therefore, the communication apparatus 151 receives the print job via the communication unit 156 that can perform communication at a speed higher than that of the short distance wireless communication unit 157.

Note that a memory such as an external HDD or an SD card may be attached as an optional device to the communication apparatus 151, and information stored in the communication apparatus 151 may be stored in the memory.

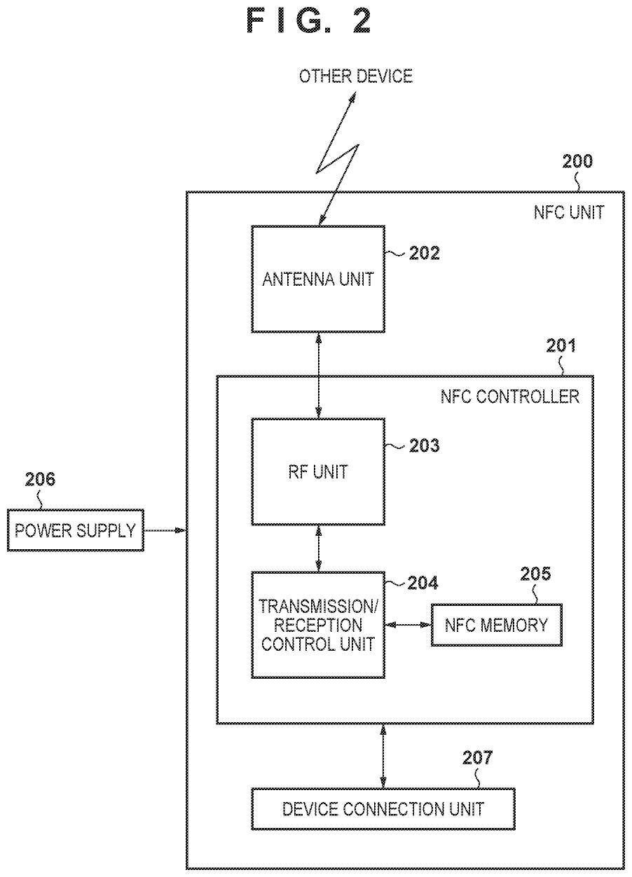

FIG. 2 is a view showing an example of the detailed configuration of the short distance wireless communication unit 111 or the short distance wireless communication unit 157. As an example of the configuration of the short distance wireless communication unit 111 and the short distance wireless communication unit 157, the configuration of an NFC unit 200 will be described. The NFC unit 200 includes an NFC controller unit 201, an antenna unit 202, an RF unit 203, a transmission/reception control unit 204, an NFC memory 205 (formed by a rewritable nonvolatile memory), a power supply 206, and a device connection unit 207. The antenna unit 202 receives a radio wave or a carrier from another NFC device (for example, the short distance wireless communication unit 111) or transmits a radio wave or a carrier to another NFC device. The RF unit 203 has a function of modulating/demodulating an analog signal to a digital signal. The RF unit 203 includes a synthesizer, and identifies the frequency of a band or a channel and controls the band or channel by frequency allocation data. The transmission/reception control unit 204 performs control associated with transmission/reception such as assembly and segmentation of transmission/reception frames, addition and detection of a preamble, and frame identification. The transmission/reception control unit 204 also controls the NFC memory 205 and reads/writes various kinds of data and programs. When operating in an active mode, the NFC unit 200 receives power supplied via the power supply 206 (the main power supply of a smartphone or an MFP), and communicates with a device via the device connection unit 207 or communicates with another NFC device within a communicable range by a carrier transmitted/received via the antenna unit 202. On the other hand, when operating in a passive mode, the NFC unit 200 receives a carrier from another NFC device via the antenna unit 202, receives power wirelessly supplied from the other NFC device by electromagnetic induction, communicates with the other NFC device by modulating the carrier, and transmits/receives data.

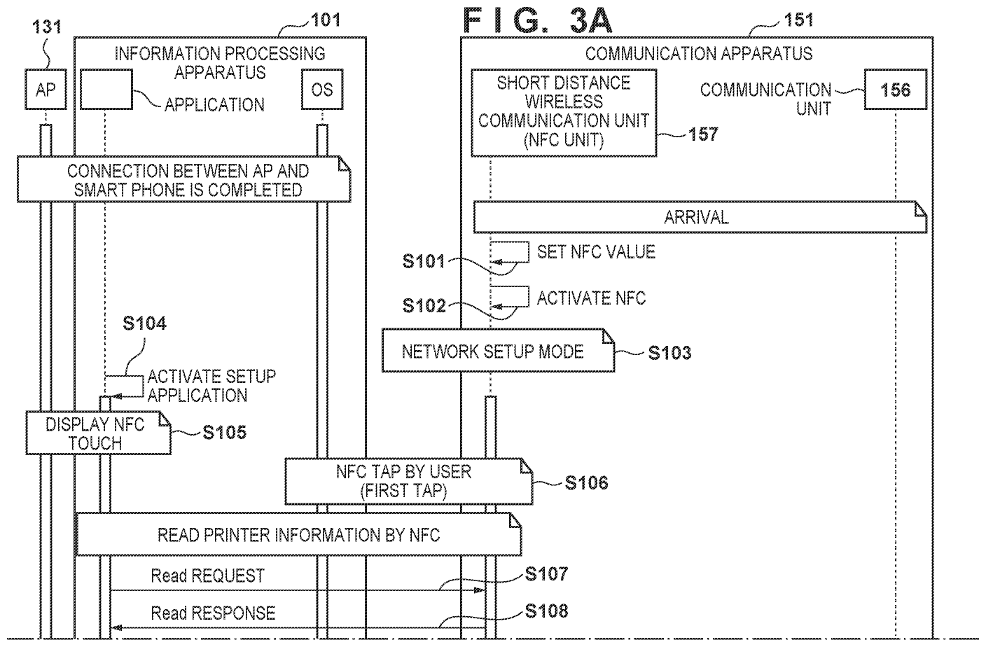

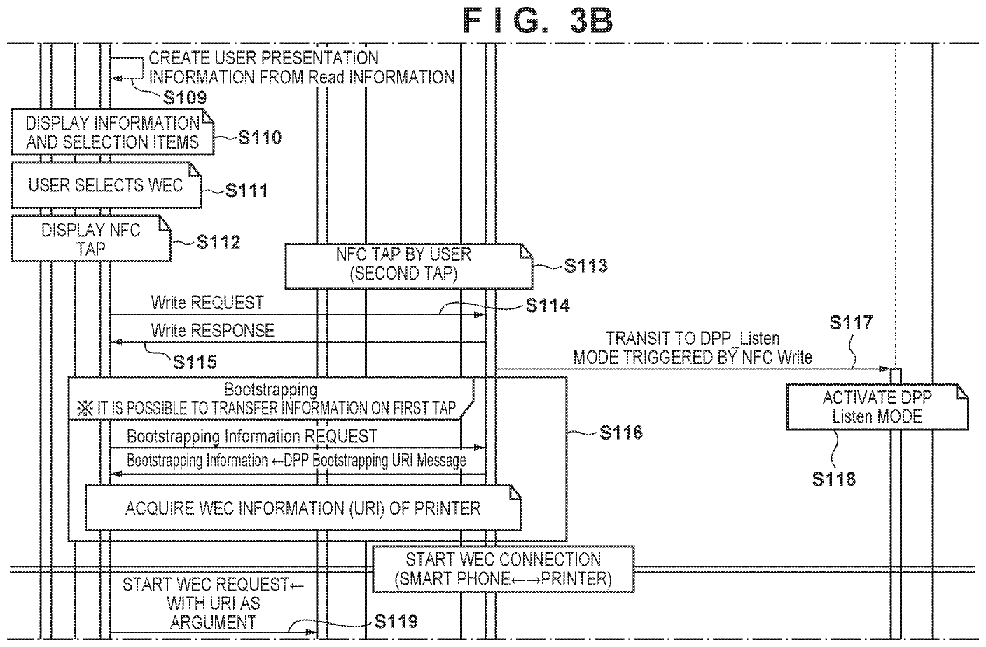

FIGS. 3A to 3C are sequences chart showing WEC connection processing executed by the information processing apparatus 101 and the communication apparatus 151. The sequence shown in FIGS. 3A to 3C is implemented by, for example, the CPU of each apparatus reading out a program stored in the ROM of each apparatus or an external storage device to the RAM of each apparatus and executing the program.

When executing the sequence shown in FIGS. 3A to 3C, the information processing apparatus 101 is already connected to the access point 131. Additionally, the user executes a power-on operation for the communication apparatus 151 in a factory shipment state (arrived state) for the first time. Note that the factory shipment state corresponds to, for example, a state in which initialization of the communication apparatus 151 is not completed yet. For example, the communication apparatus 151 is shipped from a factory without any ink tank or printhead attached. As the initialization, the communication apparatus 151 performs processing for making the communication apparatus 151 usable, for example, processing of urging the user to attach an ink tank and a printhead included in the package to the communication apparatus 151, registration adjustment, and printhead cleaning processing.

At the time of initialization, an initial value is set for the NFC memory 205 in S101, and the NFC unit is activated in step S202. At this time, the NFC unit operates as a target and waits for an instruction from an initiator.

Whether the communication apparatus 151 is in the factory shipment state or not is controlled using a flag (initial activation flag) stored in the RAM 153 or a memory. The communication apparatus 151 is configured to change the state of the initial activation flag in accordance with completion of initialization and not to activate initialization after the completion of initialization even if the communication apparatus 151 is powered on. To use the communication apparatus 151, network setup of the communication apparatus 151 is preferably executed. Hence, in this embodiment, network setup processing is executed at the time of initialization.

In S103, the CPU 154 causes the communication apparatus 151 to start (enable) an operation in a network setup mode. More specifically, the CPU 154 enables a setup access point. The operation in the network setup mode may be started by, for example, a predetermined button operation on the communication apparatus 151. Also, to end the network setup mode after the elapse of a predetermined time, the CPU 154 activates a timer for timeout of the network setup mode to count the time elapsed after the start of the operation in the network setup mode.

On the other hand, in the information processing apparatus 101, in S104, the CPU 103 reads out the setting application stored in the ROM 104 or the external storage device 106 to the RAM 105 and executes it in accordance with a user operation or the like. At this time, the CPU 103 starts the operation using the NFC unit as an initiator. In S105, the CPU 103 displays the screen of the setting application on the display unit 108. For example, an item for connection to the communication apparatus 151 such as “connect a printer” is displayed on the screen of the setting application. If the user selects the item, the CPU 103 displays, on the display unit 108, a message that urges the user to bring the information processing apparatus 101 close to the communication apparatus 151, for example, “bring the terminal close to the printer”. In S106, the user brings the NFC unit of the information processing apparatus 101 close to the NFC unit of the communication apparatus 151 (first tap).

If the NFC unit of the information processing apparatus 101 comes close to the NFC unit of the communication apparatus 151, data transmission is performed between the NFC units. More specifically, in S107, a Read request for the information of the communication apparatus 151 is transmitted from the information processing apparatus 101 to the communication apparatus 151. In S108, the information of the communication apparatus 151 is transmitted as a Read response from the communication apparatus 151 to the information processing apparatus 101.

The information of the communication apparatus 151 includes, for example, a printer name, identification information, WiFi connection information, setting enable/disable information of each setting method, the state information of the communication apparatus 151, timeout information, WEC associated information, and WFD connection information. The printer name is, for example, the name of the communication apparatus 151. The identification information includes, for example, the serial number and the MAC address of the communication apparatus 151. The WiFi connection information is, for example, information representing whether the communication apparatus is not connected to an external access point (for example, the access point 131) yet or already connected or whether the communication apparatus is not connected to an external infrastructure network yet or already connected.

A setting method of network setup processing according to this embodiment will be described here. The network setup processing can be executed by a plurality of setting methods, and the plurality of setting methods include the following four types, that is, first to fourth setting methods. The first setting method is network setup by a network setup protocol. The second setting method is network setup by DPP. Note that the second setting method need only be a method using a protocol configured to transmit connection information for connection to an AP to the communication apparatus 151 without the user inputting a password for connection to the AP to the information processing apparatus 101 after the information processing apparatus 101 and the AP are connected. For example, it may be a method by Accessory Setup that is a function of iOS or a function using HyperText Transfer Protocol (HTTP). The third setting method is network setup by WiFi Direct. Note that the third setting method need only be a setting method for connecting the communication apparatus 151 in the P2P mode to the information processing apparatus 101. Hence, this may be network setup based on the normal WiFi standard, or a setting method for connecting the communication apparatus 151 in the AP mode to the information processing apparatus 101. The fourth setting method is network setup by WiFi Protected Setup (WPS). The setting methods executed between the information processing apparatus 101 and the communication apparatus 151 are not limited to the first to fourth setting method, and network setup processing may be executed by another setting method. Setting enable/disable information of each setting method included in the information of the communication apparatus 151 is information representing whether the communication apparatus 151 has a capability of performing setting by each of the first to fourth setting methods. For example, the setting enable/disable information is based on whether the communication apparatus 151 supports each protocol or not.

The state information of the communication apparatus 151 is information representing whether each setting method can be executed in the current state of the communication apparatus 151. In the case shown in FIGS. 3A to 3C, the communication apparatus 151 is currently in the network setup mode. In this case, the state information of the communication apparatus 151 is, for example, “first setting method: possible, second setting method: possible, third setting method: enabled, fourth setting method: possible”. The state information of the communication apparatus 151 in other current states will be described later. The state information of the communication apparatus 151 may further include information representing whether the communication apparatus 151 is automatically or manually transited to the current state. For example, if the user executes the power-on operation for the first time in the factory shipment state, information representing automatic transition is included. For example, if a predetermined button operation of the communication apparatus 151 is executed, information representing manual transition is included.

The timeout information is the timeout time of network setup processing. In the case shown in FIGS. 3A to 3C, when the information of the communication apparatus 151 is transmitted in S108, the communication apparatus 151 is in the network setup mode. In the network setup mode, as described above, the setup access point is an access point that does not need a password. For this reason, a timeout time is set in network setup processing, thereby ensuring security. For example, if the communication apparatus is automatically transited to the network setup mode, the time is set to 60 min from the start of the network setup mode. If the communication apparatus is manually transited to the network setup mode, the time is set to 10 min from the start of the network setup mode. A remaining time calculated from these times is transmitted as the timeout information.

The WEC associated information is, for example, the above-described Bootstrapping information. The WEC associated information is transmitted when the communication apparatus 151 in the network setup mode. Note that the WEC associated information may not be transmitted in S108, and may be transmitted in second tap to be described later. The WFD connection information includes, for example, the SSID and password of the access point of the communication apparatus 151.

In S109, the CPU 103 generates display data to be displayed on the display unit 108 based on the information of the communication apparatus 151 received in S108. In S110, based on the display data generated in S109, the CPU 103 displays, on the display unit 108, a selection screen on which another setting method can be selected.

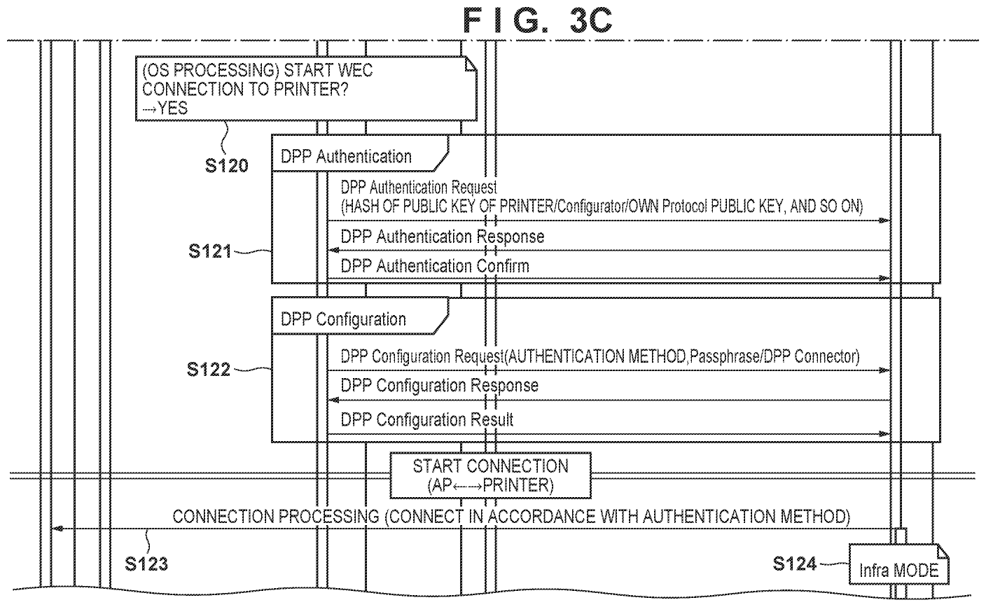

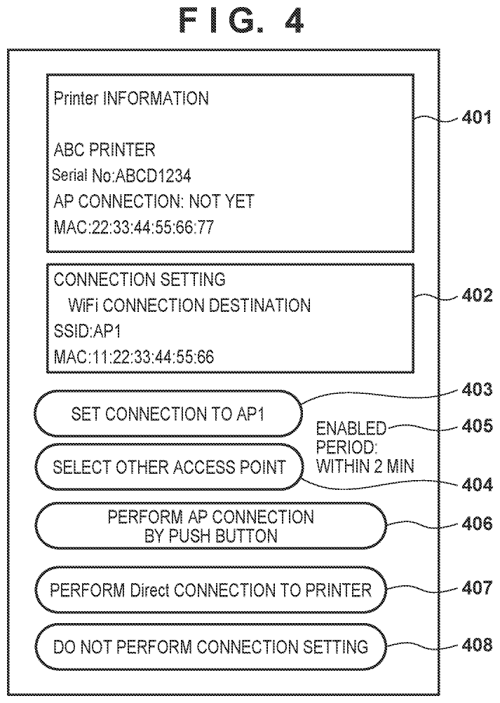

FIG. 4 is a view showing an example of the selection screen displayed in S110. The selection screen shown in FIG. 4 is displayed as a screen of the setting application. A region 401 is displayed based on the printer name, the identification information, and the WiFi connection information included in the information of the communication apparatus 151. For example, as the region 401, a printer name “ABCPRINTER”, a serial number “ABCD1234”, and a MAC address “22:33:44:55:66:77” are displayed. Also, since the current state of the communication apparatus 151 is the network setup mode, the connection state “unconnected” to an external access point is displayed. The information of the information processing apparatus 101 is displayed in a region 402. For example, as the region 402, a current WiFi connection destination “AP1” and a MAC address “11:22:33:44:55:66” are displayed. In addition, a message concerning the connection state to the Internet may be displayed as the region 402.

Selection items 403, 404, 406, and 407 indicate the setting methods selectable by the user, which are displayed based on the information of the communication apparatus 151 received in S108. In the case shown in FIGS. 3A to 3C, since the communication apparatus 151 is in the network setup mode, the state information of the communication apparatus 151 is “first setting method: possible, second setting method: possible, third setting method: enabled, fourth setting method: possible”. Hence, in FIG. 4, the selection items 403 and 404 corresponding to the second setting method, the selection item 407 corresponding to the third setting method, and the selection item 406 corresponding to the fourth setting method are displayed to allow the user to select another setting method other than the first setting method. As will be described later, in this embodiment, if both the first setting method and the second setting method are executable, the second setting method is preferentially displayed as a selection item.

The selection item 403 is pressed to set, for the communication apparatus 151, connection to the current WiFi connection destination (external access point) of the information processing apparatus 101, which is displayed in the region 402. The selection item 404 is pressed to select an external access point other than the current WiFi connection destination of the information processing apparatus 101, which is displayed in the region 402. A timeout time 405 is displayed based on the timeout information included in the information of the communication apparatus 151. When the timeout time 405 is displayed, the user can be caused to recognize the remaining time in which network setup processing can be performed.

The selection item 406 is pressed to select network setup processing (fourth setting method) using WPS. The selection item 407 is pressed when the user selects network setup processing (third setting method) using WiFi Direct. A selection item 408 is pressed when network setup processing is not performed.

In S111, the CPU 103 accepts user selection on the selection screen shown in FIG. 4. Here, a description will be made assuming that the selection item 403 or 404 in FIG. 4 is selected. If the selection item 403 is pressed, the CPU 103 acquires information about an external access point (to be referred to as a connected AP hereinafter) to which the information processing apparatus 101 is wirelessly connected at least when the setting operation is performed. The information includes information (information representing an SSID, an encryption method, and the like) used to connect to the access point to which the information processing apparatus 101 is wirelessly connected by WiFi. Note that the acquired information is stored in a predetermined storage area of the memory of the information processing apparatus 101. If the selection item 404 is pressed, the CPU 103 instructs the OS of the information processing apparatus 101 to search for an access point around the information processing apparatus 101 and acquires the search result by the setting application. The CPU 103 then displays, on the display unit 108, a screen that displays the search result in a selectable state. The CPU 103 acquires information (information representing an SSID, an encryption method, and the like) about an access point selected by the user and stores the acquired information in a predetermined storage area of the memory of the information processing apparatus 101.

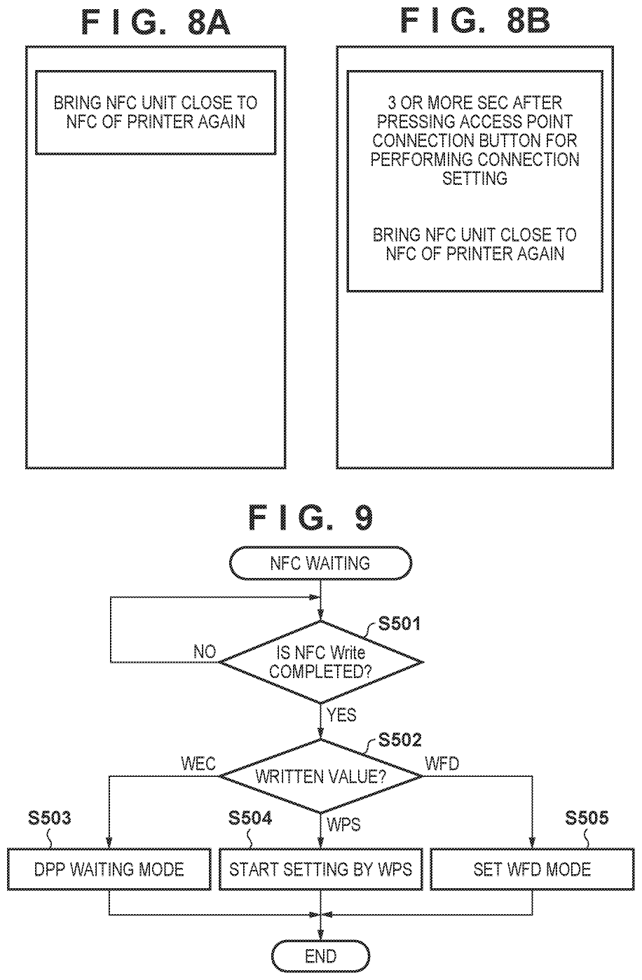

In S112, the CPU 103 displays, on the display unit 108, a message that urges the user to bring the NFC unit of the information processing apparatus 101 close to the NFC unit of the communication apparatus 151, for example, “bring the terminal close to the printer again”. FIG. 8A shows an example of a screen displayed at this time. In S113, the user brings the NFC unit of the information processing apparatus 101 close to the NFC unit of the communication apparatus 151 (second tap).

If the NFC unit of the information processing apparatus 101 comes close to the NFC unit of the communication apparatus 151, data transmission is performed between the NFC units. More specifically, in S114, a Write request is transmitted from the information processing apparatus 101 to the communication apparatus 151. In S115, a Write response is transmitted from the communication apparatus 151 to the information processing apparatus 101. The Write request transmitted in S114 includes information corresponding to the selection result in S111. That is, a value corresponding to the selected setting method is written in the NFC memory of the communication apparatus 151.

A description will be made below assuming that the selection item 403 is selected on the screen shown in FIG. 4. That is, in S114, a value corresponding to the selection item 403 is transmitted as a Write request.

If the WEC associated information is not transmitted in S108, as S116 in the second tap, a request for the WEC associated information is transmitted from the information processing apparatus 101 to the communication apparatus 151. The WEC associated information is, for example, Bootstrapping information. Then, the WEC associated information is transmitted from the communication apparatus 151 to the information processing apparatus 101. If the WEC associated information is already transmitted in S108, S116 is not executed.

In S117, if the value is written in the NFC memory, the CPU 154 causes the communication apparatus 151 to start an operation in the DPP waiting mode. The DPP waiting mode will be described later with reference to FIG. 12. In addition, a timer for timeout of the DPP waiting mode is activated to count the time elapsed after the start of the operation in the DPP waiting mode. After that, in S118, the communication apparatus 151 is set in the DPP waiting mode.

In S119 to S122, the CPU 103 executes WEC using the acquired WEC associated information. Note that in this embodiment, instead of directly executing WEC, the setting application performs processing of activating a WEC application program (to be referred to as a WEC application hereinafter) of OS standard as processing for executing WEC. When API for WEC is executed by the WEC application to make a WEC execution request for the OS, WEC is executed by the OS. Note that API for WEC may be executed from the setting application to make the WEC execution request for the OS, and processing for executing WEC may be the execution request. Details of the processes of S119 to S122 will be described later with reference to FIG. 10.

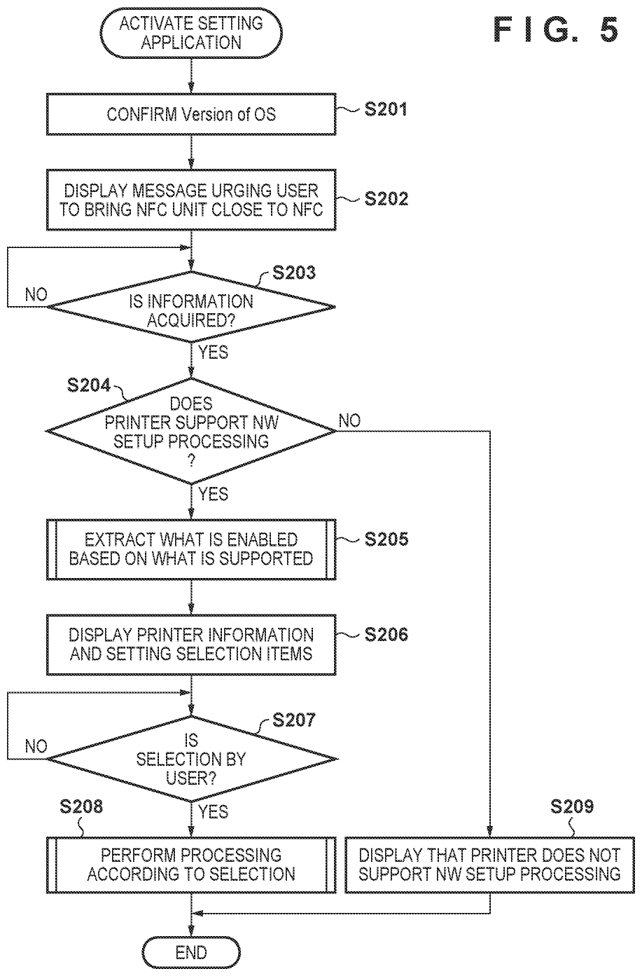

FIG. 5 is a flowchart showing processing executed by the information processing apparatus 101. The processing shown in FIG. 5 is implemented by, for example, the CPU 103 reading out a program stored in the ROM 104 or the external storage device 106 to the RAM 105 and executing the program. The processing shown in FIG. 5 is started when the setting application is executed in S104 of FIG. 3A.

In step S201, the CPU 103 acquires the version information of the operating system program (OS) of the information processing apparatus 101. In step S202, the CPU 103 displays, on the display unit 108, a message that urges the user to bring the NFC unit of the information processing apparatus 101 close to the NFC unit of the communication apparatus 151. Step S202 corresponds to S105 in FIG. 3A. In step S203, the CPU 103 determines whether the information of the communication apparatus 151 is acquired from the communication apparatus 151. Here, if it is not determined that the information of the communication apparatus 151 is acquired, the process of step S203 is repeated. If it is determined that the information of the communication apparatus 151 is acquired, the process advances to step S204. For example, if the information of the communication apparatus 151 is included in the Read response from the communication apparatus 151 in S108 of FIG. 3A, it is determined that the information of the communication apparatus 151 is acquired, and the process advances to step S204.

In step S204, the CPU 103 determines, based on the acquired information of the communication apparatus 151, whether the communication apparatus 151 supports network setup processing. The determination in step S204 is done based on, for example, the printer name and the identification information included in the information of the communication apparatus 151. For example, if it is determined that the printer is of a maker other than the company, or information about selection items on the selection screen shown in FIG. 4 is not included at all in the information of the communication apparatus 151, it is determined that the communication apparatus 151 does not support network setup processing, and the process advances to step S209. In step S209, the CPU 103 displays, on the display unit 108, a notification screen that shows a message representing that network setup processing cannot be executed for the communication apparatus 151, and then ends the processes shown in FIGS. 3 and 5. On the other hand, if it is determined in step S204 that the communication apparatus 151 supports network setup processing, the process advances to step S205.

In step S205, the CPU 103 extracts each item to be displayed as a selection item on the selection screen shown in FIG. 4.

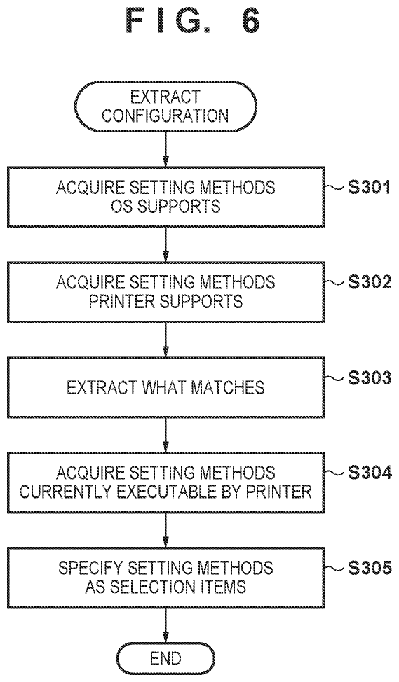

FIG. 6 is a flowchart showing the process of step S205. In step S301, the CPU 103 acquires setting methods supported by the OS of the information processing apparatus 101 based on the version information of the OS acquired in step S201. For example, the version information of the OS and information representing whether the OS supports the first to fourth setting methods are stored in the ROM 104 or the external storage device 106 in association with each other. The CPU 103 acquires setting methods supported by the OS by referring to these pieces of information. In step S302, based on the setting enable/disable information of each setting method included in the information of the communication apparatus 151 acquired in S108 of FIG. 3A, the CPU 103 acquires setting methods supported by the communication apparatus 151. In step S303, the CPU 103 extracts matching setting methods from the setting methods acquired in step S301 and the setting methods acquired in step S302. That is, setting methods that both the information processing apparatus 101 and the communication apparatus 151 have as a common capability are acquired in steps S301 to S303.

In step S304, based on the state information of the communication apparatus 151 included in the information of the communication apparatus 151 acquired in S108 of FIG. 3A, the CPU 103 acquires setting methods executable in the current state of the communication apparatus 151.

In step S305, the CPU 103 specifies setting methods that match between the setting methods extracted in step S303 and the setting methods acquired in step S304 as selection items to be displayed in S110 of FIG. 3B. At this time, if both the first setting method and the second setting method are extracted in step S303 and acquired even in step S304, the CPU 103 specifies the second setting method as a selection item to be displayed. That is, the first setting method is not specified as a selection item to be displayed. After step S305, the processing shown in FIG. 6 is ended.

By steps S304 and S305, setting methods that both the information processing apparatus 101 and the communication apparatus 151 have as a common capability and that can be executed in the current state of the communication apparatus 151 are specified. This configuration can prevent a situation in which, for example, a selection item corresponding to network setup by DPP is displayed on the side of the information processing apparatus 101 even though the communication apparatus 151 does not support WEC. Also, if both network setup by a network setup protocol and network setup by DPP are possible, network setup by DPP is preferentially displayed as a selection item. With this configuration, a setting method that does not need input of information such as a password and is therefore more convenient can be presented to the user.

After step S305, in step S206 of FIG. 5, the CPU 103 generates display data to be displayed on the display unit 108 based on the information of the communication apparatus 151 received in S108, and displays the display data on the display unit 108. The display data generated here is data to display, for example, the selection screen shown in FIG. 4. Step S206 in FIG. 5 corresponds to S109 and S110 in FIG. 3B.

In step S207, the CPU 103 determines whether selection by the user is accepted. The selection here is, for example, selection of one of the selection items 403, 404, and 406 to 408 shown in FIG. 4. The process of step S207 is repeated until it is determined that selection by the user is accepted. If it is determined that selection by the user is accepted, the process advances to step S208.

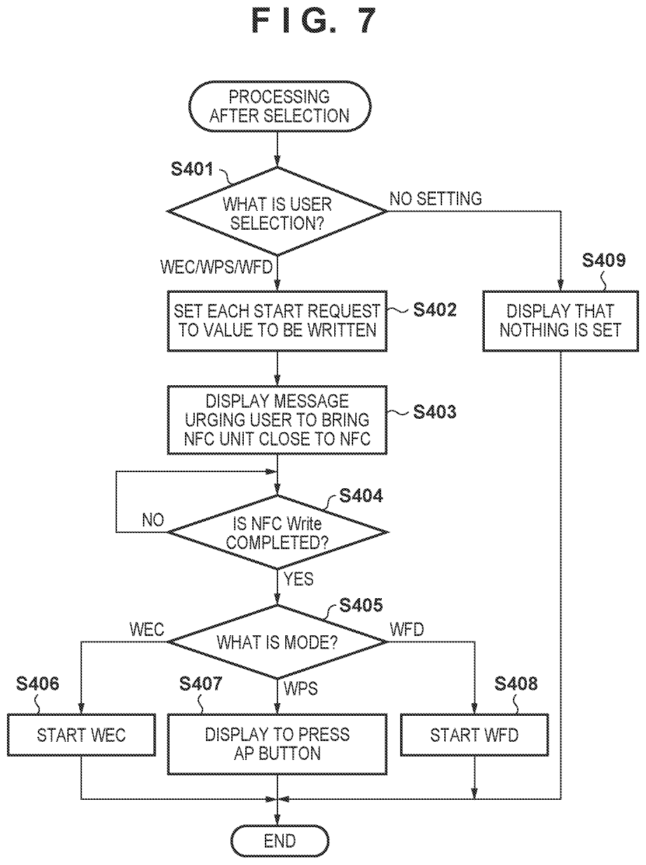

In step S208, the CPU 103 performs processing according to the selection result accepted in step S207. The process of step S208 will be described with reference to FIG. 7. After step S208, the processing shown in FIG. 5 is ended.

FIG. 7 is a flowchart showing the process of step S208. In step S401, if the selection result accepted in step S207 is one of network setup using DPP (second setting method), network setup using WiFi Direct (third setting method), and network setup using WPS (fourth setting method), the CPU 103 advances to step S402. For example, if one of the selection items 403, 404, 406, and 407 in FIG. 4 is selected, the process advances to step S402. On the other hand, if the selection result accepted in step S207 indicates an item that does not execute network setup, the process advances to step S409. For example, if the selection item 408 in FIG. 4 is selected, the process advances to step S409. In step S409, the CPU 103 displays, on the display unit 108, a message screen showing that network setup processing is not to be executed, and then ends the processing shown in FIG. 7. Note that if the selection item 408 is pressed, a screen configured to perform network setup (first setting method) by the network setup protocol may be displayed. The screen configured to perform network setup by the network setup protocol is, for example, a screen used to select an access point to be set for connection to the communication apparatus 151 or input the information (password and the like) of the access point.

In step S402, the CPU 103 sets a value corresponding to the selection result accepted in step S207 as a Write request to be transmitted to the communication apparatus 151 in S114. In step S403, the CPU 103 displays, on the display unit 108, a message screen that urges the user to bring the information processing apparatus 101 close to the communication apparatus 151, for example, “bring the terminal close to the printer”. The process of step S403 corresponds to S113 in FIG. 3B. FIG. 8A is a view showing an example of the screen displayed in step S403.

In step S404, the CPU 103 determines whether the Write request to the communication apparatus 151 is completed. The determination in step S404 is done based on, for example, whether a Write response from the communication apparatus 151 is received. The process of step S404 is repeated until it is determined that the Write request to the communication apparatus 151 is completed. If it is determined that the Write request to the communication apparatus 151 is completed, the process advances to step S405.

In step S405, the CPU 103 switches control to execute processing according to the selection result accepted in step S207. If the selection result accepted in step S207 indicates the second setting method, the process advances to step S406. In step S406, the CPU 103 starts processing for executing WEC using the acquired WEC associated information. More specifically, for example, processing of activating a WEC application of OS standard is performed. At this time, for example, Bootstrapping information acquired from the communication apparatus 151 is transferred as a URI parameter to the OS. After step S406, the processing shown in FIG. 7 is ended.

Also, if the selection result accepted in step S207 indicates the fourth setting method, the process advances to step S407. In step S407, the CPU 103 displays a message that urges the user to press a connection button for an access point to be set for connection. FIG. 8B is a view showing an example of the screen displayed in step S407. After step S407, the processing shown in FIG. 7 is ended.

Also, if the selection result accepted in step S207 indicates the third setting method, the process advances to step S408. In step S408, the CPU 103 starts processing for connecting the communication apparatus 151 by WiFi Direct. More specifically, for example, connection to the access point to which the information processing apparatus 101 is currently connected is disconnected, and the communication apparatus 151 operating in the WFD mode is connected by WiFi Direct based on WFD connection information received in S108 of FIG. 3A. Note that the communication apparatus 151 operating in the AP mode may be WiFi-connected by P2P. After step S408, the processing shown in FIG. 7 is ended.

FIG. 9 is a flowchart showing processing executed by the communication apparatus 151. The processing shown in FIG. 9 is implemented by, for example, the CPU 154 reading out a program stored in the ROM 152 or an external storage device to the RAM 153 and executing the program. The processing shown in FIG. 9 is started after the Read response is transmitted to the information processing apparatus 101 in S108 of FIG. 3A.

In step S501, the CPU 154 determines whether write from the information processing apparatus 101 is completed by the approach of the NFC unit of the information processing apparatus 101. For example, if a Write request is transmitted from the information processing apparatus 101, and a Write response is transmitted to the information processing apparatus 101, the CPU 154 determines that write from the information processing apparatus 101 is completed. The process of step S501 is repeated until it is determined that write from the information processing apparatus 101 is completed. If it is determined that write from the information processing apparatus 101 is completed, the process advances to step S502.

In step S502, the CPU 154 switches control to execute processing according to the value written from the information processing apparatus 101 in step S501. If the value written in step S501 is a value indicating the second setting method, in step S503, the CPU 154 makes the communication apparatus 151 transition to a mode for waiting for a DPP Authentication Request. After step S503, the processing shown in FIG. 9 is ended.

If the value written in step S501 is a value indicating the fourth setting method, in step S504, the CPU 154 starts setting by WPS. More specifically, for example, after the screen shown in FIG. 8B is displayed, an external access point for which the WPS button is pressed is searched for. After step S504, the processing shown in FIG. 9 is ended.

If the value written in step S501 is a value indicating the third setting method, in step S505, the CPU 154 sets the communication apparatus 151 in the WiFi Direct mode. More specifically, for example, a beacon signal is transmitted, thereby making the access point of the communication apparatus 151 itself searchable from an external apparatus (for example, the information processing apparatus 101). After step S505, the processing shown in FIG. 9 is ended.

Processing executed by the information processing apparatus 101 and the communication apparatus 151 after S119 in FIG. 3B will be described next with reference to FIG. 10. The sequence shown in FIG. 10 is implemented by, for example, the CPU of each apparatus reading out a program stored in the ROM of each apparatus or an external storage device to the RAM of each apparatus and executing the program.

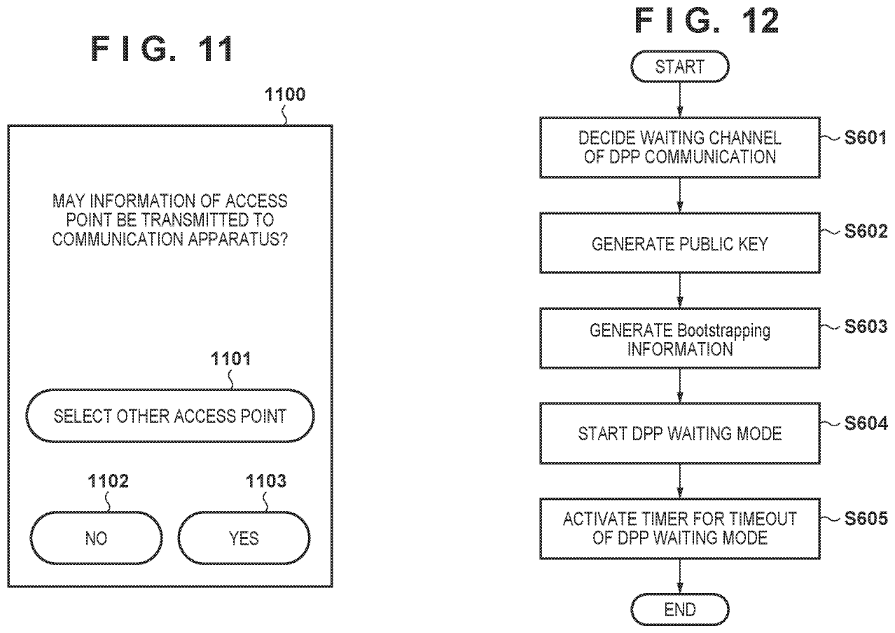

First, in S510, the information processing apparatus 101 starts WEC using DPP by the function of the OS. More specifically, first, the information processing apparatus 101 instructs from the setting application to the OS to activate the WEC application, thereby activating the WEC application. Thus, the WEC application operates in the foreground, and the setting application operates in the background. Note that, for example, execution of the instruction corresponds to an instruction to execute WEC. Thus, the information processing apparatus 101 displays a WEC start screen by the WEC application. Note that the WEC application is a program installed in advance in the information processing apparatus 101, and is a program provided by the OS vendor of the information processing apparatus 101. If the WEC application is activated, WEC associated information acquired by the setting application is provided to the WEC application. FIG. 11 shows an example of the WEC start screen displayed by the WEC application. Regions 1101, 1102, and 1103 are displayed on a WEC start screen 1100. The region 1101 is a region configured to change an access point set as a setting target of WEC. Note that before the region 1101 is operated, the access point set as the setting target of WEC is the access point currently connected to the information processing apparatus 101. If the region 1101 is selected, the information processing apparatus 101 displays a list of access points, and sets an access point selected from the list by the user newly as the setting target of WEC. Note that the list of access points includes, for example, access points that the information processing apparatus 101 has found by AP search and access points to which the information processing apparatus 101 has been connected once. The region 1102 is a region used to cancel execution of WEC, and the region 1103 is a region used to instruct execution of WEC. If the region 1102 is operated, the information processing apparatus 101 ends the processing shown in the sequence chart. Note that in this case, it is considered that WEC has failed. Also, if the region 1103 is pressed, the information processing apparatus 101 advances to S511. Note that S510 corresponds to S120 in FIG. 3C.

In S511, the WEC application executes API for WEC using WEC associated information and information about the access point set as the setting target of WEC, thereby instructing the OS to execute WEC. Then, processing called DPP Authentication is executed between the information processing apparatus 101 and the communication apparatus 151 by the function of the OS. In the DPP Authentication, authentication information and information used to encrypt information are communicated between the information processing apparatus 101 and the communication apparatus 151, thereby authenticating communication between the apparatuses. Note that various kinds of information transmitted from the information processing apparatus 101 in the communication of DPP Authentication are encrypted based on the WEC associated information acquired by the information processing apparatus 101. More specifically, in the DPP Authentication, first, the information processing apparatus 101 transmits an Authentication Request as a network setup request by DPP. Next, the communication apparatus 151 operating in the DPP waiting mode is operating in the DPP waiting mode that is a mode for waiting for the Authentication Request and thus receives the Request transmitted from the information processing apparatus 101. Upon receiving the Authentication Request, the communication apparatus 151 attempts to decrypt the received Request using a decryption key currently held by the communication apparatus. If the decryption succeeds, the communication apparatus 151 transmits an Authentication response to the information processing apparatus 101, thereby authenticating communication with the information processing apparatus 101. Note that if the information processing apparatus 101 cannot acquire correct WEC associated information, and the information cannot correctly be encrypted, decryption by the communication apparatus 151 fails. For this reason, authentication fails, and the Authentication response is not transmitted. When the information processing apparatus 101 receives the Authentication response, the DPP Authentication is completed. Also, in the DPP Authentication, communication is executed using DPP.

Next, in S512, processing called DPP Configuration is executed between the information processing apparatus 101 and the communication apparatus 151 by the function of the OS. In the DPP Configuration, the information processing apparatus 101 transmits connection information used to connect the access point set as the setting target of WEC to the communication apparatus 151 by WEC. Note that the connection information includes information representing the SSID, the password, and the encryption method of the access point set as the setting target of WEC. The password transmitted at this time is information input by the user on a screen displayed by an application supporting the OS when the connection between the information processing apparatus 101 and the access point is established. This is information held by the OS when the connection between the information processing apparatus 101 and the access point is established. Also, the password is information that the setting application does not hold. Since the password transmitted at this time is information already held by the OS, and the DPP Configuration is processing executed by the OS, the password need not newly be input by the user on the screen displayed by the setting application. When the connection information is transmitted by WEC, as in this embodiment, the password can be transmitted to the communication apparatus 151 by secure communication without newly accepting input of the password from the user on the screen displayed by the setting application. Note that even in the DPP Configuration, communication is executed using DPP. Note that in this embodiment, communication in the DPP Authentication and the DPP Configuration is performed by beacon transmission of each apparatus. Also, in this embodiment, in the DPP Authentication and the DPP Configuration, the communication apparatus 151 receives a beacon transmitted from the information processing apparatus 101 by a network interface for infrastructure connection.

In S513, the communication apparatus 151 ends the DPP waiting mode and transitions to an infrastructure mode. Then, using the connection information acquired by WEC, the communication apparatus 151 attempts connection to an access point corresponding to the connection information. If connection succeeds, the communication apparatus 151 can execute communication via a network formed by the connected access point from then on. Note that the communication via the network formed by the connected access point is executed by a protocol (more specifically, for example, a protocol unique to the vendor of the communication apparatus 151, such as Port 9100 or SNMP) different from DPP. Note that the communication apparatus 151 may transmit, to the information processing apparatus 101, information representing whether connection to the access point corresponding to the connection information acquired by WEC succeeds or not. Furthermore, if connection to the access point corresponding to the connection information acquired by WEC fails, information representing the cause of the failure may be transmitted to the information processing apparatus 101. The information transmission may be executed using DPP. Note that the connection to the access point corresponding to the connection information acquired by WEC fails because a communication error occurs in WEC, the access point cannot be found, or the WEC associated information acquired from the communication apparatus 151 is not appropriate information. The connection fails also because, for example, the encryption method used to connect to the access point set as the setting target of WEC is an encryption method that the communication apparatus 151 does not support. The connection fails also because, for example, the encryption method used to connect to the access point set as the setting target of WEC is an encryption method that WEC does not support. Note that the information processing apparatus 101 may display, on the display unit 108, information representing whether connection to the access point corresponding to the connection information acquired by WEC succeeds or not. If the connection to the access point corresponding to the connection information acquired by WEC fails, information representing the cause of the failure may be displayed on the display unit 108.

In S514, based on the end of execution of WEC, the information processing apparatus 101 switches the application operating in the foreground from the WEC application to the setting application. Then, the information processing apparatus 101 searches for the communication apparatus 151 on the network to which the information processing apparatus 101 itself belongs. This processing is implemented by the setting application that has received, from the OS, a notification representing that execution of WEC is ended. If the communication apparatus 151 is found, the information processing apparatus 101 requests capability information from the communication apparatus 151, and the communication apparatus 151 transmits the capability information to the information processing apparatus 101. Hence, the information of the communication apparatus 151 is registered on the setting application, and communication with the communication apparatus 151 can be executed by the setting application from then on. More specifically, for example, a print job can be transmitted to the communication apparatus 151 by the setting application. Note that at this time, if the information processing apparatus 101 belongs to the network formed by the access point to which the communication apparatus 151 is connected by WEC, communication with the communication apparatus 151 can be executed via the access point. Also, if communication between the information processing apparatus 101 and the communication apparatus 151 cannot be executed because, for example, the access point to which the communication apparatus 151 is connected is not the access point to which the information processing apparatus 101 is connected, the request or acquisition of capability information is omitted. Note that the communication in S514 is executed using, for example, a communication protocol (more specifically, for example, CHMP) different from DPP and the network setup protocol. After that, the information processing apparatus 101 ends the processing shown in the sequence chart.

Note that a form in which the WEC start screen is displayed by the WEC application, and the WEC application executes API of WEC to instruct the OS to execute WEC has been described above. However, the present invention is not limited to this form. For example, the WEC start screen may be displayed by the setting application. In addition, the setting application may execute API of WEC to instruct the OS to execute WEC.

The process in S118 of FIG. 3B will be described here with reference to FIG. 12.

FIG. 12 is a flowchart showing the contents of DPP waiting mode start processing. The flowchart shown in FIG. 12 is implemented by, for example, the CPU 154 reading out the setting application stored in the ROM 152 or a memory to the RAM 153 and executing the setting application. The processing shown in FIG. 12 is started when the value of the second setting method is written in the NFC memory in S114 and S117 of FIG. 3B.

In step S601, the CPU 154 decides a waiting channel of DPP communication. The waiting channel of DPP communication means a channel that waits for a network setup request by DPP, which is transmitted from the information processing apparatus 101. The same channel is used in the DPP Configuration. Note that which channel is used as the waiting channel of DPP communication may be set, for example, by the user from the operation screen of the communication apparatus 151.

In step S602, the CPU 154 generates the above-described public key information used to perform secure communication with the information processing apparatus 101.

In step S603, the CPU 154 generates the above-described Bootstrapping information. The Bootstrapping information includes, for example, the identification information (the MAC address or the like) of the communication apparatus 151, information about the waiting channel of the DPP communication, and the public key information generated in step S602.

Note that in FIG. 12, the description is made assuming that the Bootstrapping information is transmitted in S116 of FIG. 3B. If the Bootstrapping information is transmitted in S108, for example, the processes of steps S601 to S603 may be executed according to the transition to the network setup mode in S103 of FIG. 3A as a trigger.

In step S604, the CPU 154 starts the DPP waiting mode. If the DPP waiting mode is started, communication in the DPP Authentication can be performed between the communication apparatus 151 and the information processing apparatus 101.

In step S605, the CPU 154 activates a timer for timeout of the DPP waiting mode. Note that if a predetermined time elapses from the start of the operation in the DPP waiting mode, the CPU 154 stops the operation in the DPP waiting mode.

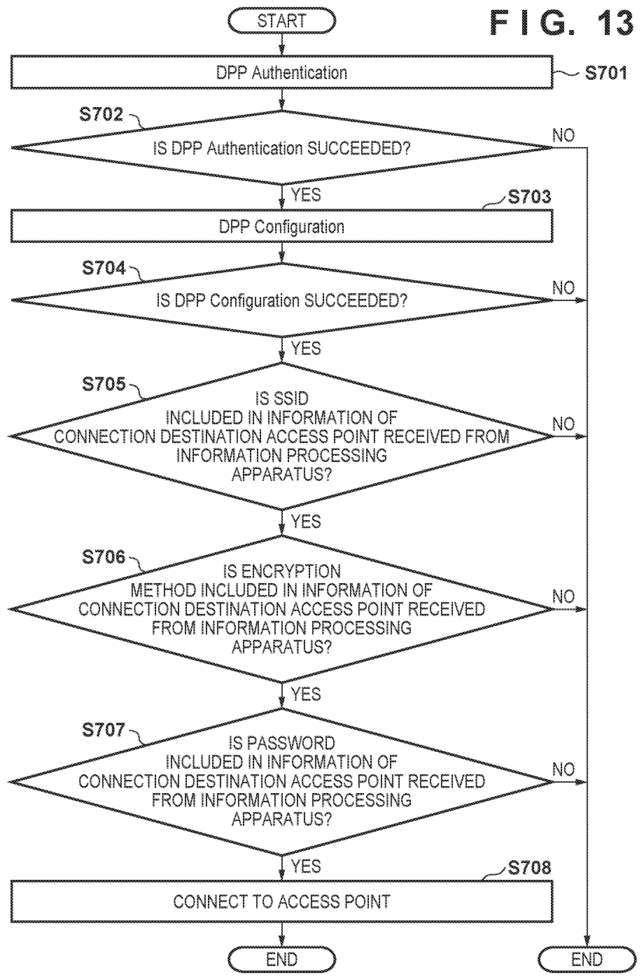

FIG. 13 is a flowchart showing execution processing of network setup (WEC) using DPP, and corresponds to the operation of the communication apparatus 151 in the sequence of FIG. 10. The flowchart shown in FIG. 13 is implemented by, for example, the CPU 154 reading out the setting application stored in the ROM 152 or a memory to the RAM 153 and executing the setting application. The flowchart shown in FIG. 13 is started based on the communication apparatus 151 receiving a WEC execution request in the DPP Authentication processing from the information processing apparatus 101.

In step S701, the CPU 154 executes DPP Authentication processing. As described above, in the DPP Authentication processing, authentication information and information used to encrypt information are communicated between the information processing apparatus 101 and the communication apparatus 151, thereby authenticating communication between the apparatuses. Note that in the DPP Authentication, communication is executed using DPP.

In step S702, the CPU 154 determines whether the DPP Authentication processing with the information processing apparatus 101 succeeds. As described above, various kinds of information transmitted from the information processing apparatus 101 in the communication of DPP Authentication are encrypted based on the WEC associated information acquired by the information processing apparatus 101. If the information received from the information processing apparatus 101 is successfully decoded by a decryption key held in advance, the CPU 154 authenticates the communication with the information processing apparatus 101. Note that if the information processing apparatus 101 cannot acquire correct WEC associated information, and the information cannot correctly be encrypted, decryption by the communication apparatus 151 fails. For this reason, authentication fails. Hence, if the authentication of communication with the information processing apparatus 101 succeeds, the CPU 154 determines that the DPP Authentication processing succeeds. If the authentication fails, the CPU 154 determines that the DPP Authentication processing fails. If NO in step S702, the CPU 154 ends the flowchart. On the other hand, if YES in step S702, the CPU 154 advances to step S703.

In step S703, the CPU 154 executes DPP Configuration processing. In the DPP Configuration processing, the CPU 154 receives connection information used to connect to an access point set as the setting target of WEC from the information processing apparatus 101 by WEC. Note that the connection information includes information representing the SSID, the password, and the encryption method of the access point set as the setting target of WEC.

In step S704, the CPU 154 determines whether the DPP Configuration processing with the information processing apparatus 101 succeeds. More specifically, if the connection information used to connect to the access point set as the setting target of WEC is received from the information processing apparatus 101 by WEC, the CPU 154 determines that the DPP Configuration processing succeeds. If the connection information cannot be received, the CPU 154 determines that the DPP Configuration processing fails. If NO in step S704, the CPU 154 ends the flowchart. On the other hand, if YES in step S704, the CPU 154 advances to step S705. Note that if the DPP Configuration processing succeeds, the CPU 154 acquires the SSID, the encryption method, and the password of the access point.

In step S705, the CPU 154 determines whether an SSID is included in the information of the access point set as the setting target of WEC, which is received from the information processing apparatus 101. If NO in step S705, the CPU 154 ends the flowchart. On the other hand, if YES in step S705, the CPU 154 advances to step S706.

In step S706, the CPU 154 determines whether an encryption method is included in the information of the access point set as the setting target of WEC, which is received from the information processing apparatus 101. If NO in step S706, the CPU 154 ends the flowchart. On the other hand, if YES in step S706, the CPU 154 advances to step S707.

In step S707, the CPU 154 determines whether a password is included in the information of the access point set as the setting target of WEC, which is received from the information processing apparatus 101. Note that if the communication apparatus is connected to the access point using DPP communication, the CPU 154 may determine whether not a password but public key information is included. If NO in step S707, the CPU 154 ends the flowchart. On the other hand, if YES in step S707, the CPU 154 ends the DPP waiting mode. When the DPP waiting mode is ended, the CPU 154 cannot meet the request of DPP Authentication processing from the information processing apparatus 101.

In step S708, the CPU 154 connects to the access point using the various kinds of information (the SSID, the password, and the encryption method) of the access point set as the setting target of WEC, which is received from the information processing apparatus 101. The CPU 154 then ends the flowchart.

As described above, in this embodiment, if the communication apparatus 151 is in the network setup mode, and a setting method other than the network setup protocol can be executed, a selection screen on which another setting method can be selected is displayed on the information processing apparatus 101. More specifically, for example, a selection screen on which network setup by DPP and network setup by WiFi Direct can be selected is displayed. If selection is accepted on the selection screen, processing corresponding to the selected setting method is started. With this configuration, convenience can be improved because the user never performs operations on the communication apparatus 151.

In this embodiment, the configuration in the case where the communication apparatus 151 is in the network setup mode, as shown in FIGS. 3A to 3C, has been described. A case where the communication apparatus 151 is in another state will be described below.

First, a case where the information processing apparatus 101 is already connected to the access point 131 (to be referred to as an access point A), and the communication apparatus 151 is already connected to another access point (to be referred to as an access point B) will be described.

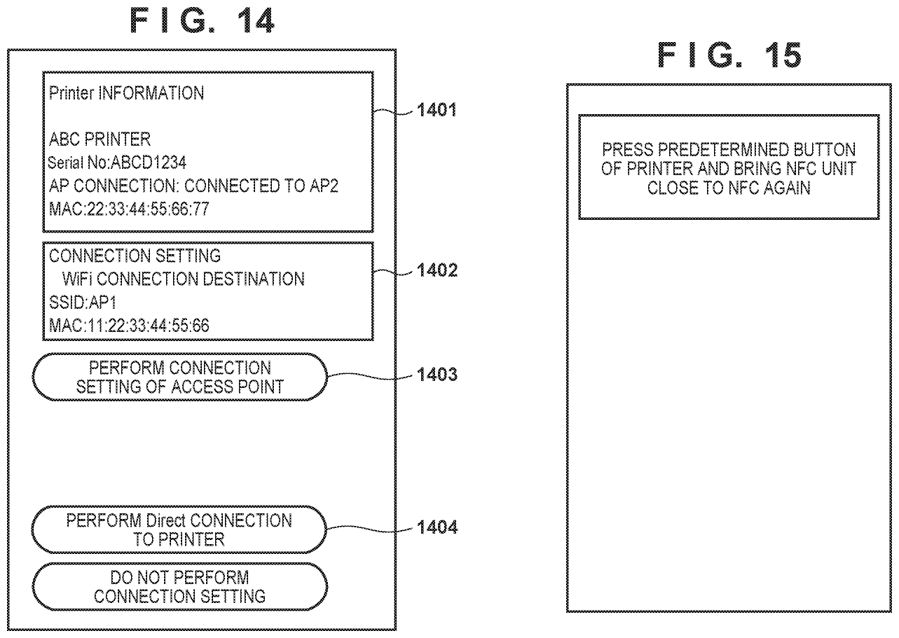

The information processing apparatus 101 performs the processes of S104 to S107 in FIG. 3A. In S108, the information of the communication apparatus 151 is transmitted as a Read response from the communication apparatus 151 to the information processing apparatus 101. Since the communication apparatus 151 is currently connected to the access point B, the state information of the communication apparatus 151 is “first setting method: impossible, second setting method: impossible, third setting method: enabled, fourth setting method: impossible”. In this case, in S110, a screen shown in FIG. 14 is displayed on the information processing apparatus 101. As shown in FIG. 14, in this case, the connection state to an external access point in a region 1401 of the selection screen is “connected to AP2”. Also, as shown in FIG. 14, a selection item 1404 corresponding to the third setting method is displayed on the selection screen. On the other hand, since the communication apparatus 151 is connected to the access point B, items corresponding to the selection items 403, 404, and 406 in FIG. 4 are not displayed. In addition, a selection item 1403 used to connect the communication apparatus 151 to the access point A is displayed.

Here, if the selection item 1403 is selected, in S114 of FIG. 3B, information corresponding to the selection item 1403 is transmitted as a Write request to the communication apparatus 151. Also, if the selection item 1403 is selected, a screen that urges the user to do a predetermined operation of the communication apparatus 151 and bring the NFC unit of the information processing apparatus 101 close to the NFC unit of the communication apparatus 151 is displayed on the information processing apparatus 101. FIG. 15 shows an example of the screen displayed at this time. When the screen shown in FIG. 15 is displayed, for example, a warning message “connection between the printer and the access point B is disconnected” may be displayed. If the user performs the predetermined operation, the communication apparatus 151 disconnects the connection to the access point B and transitions to the network setup mode.

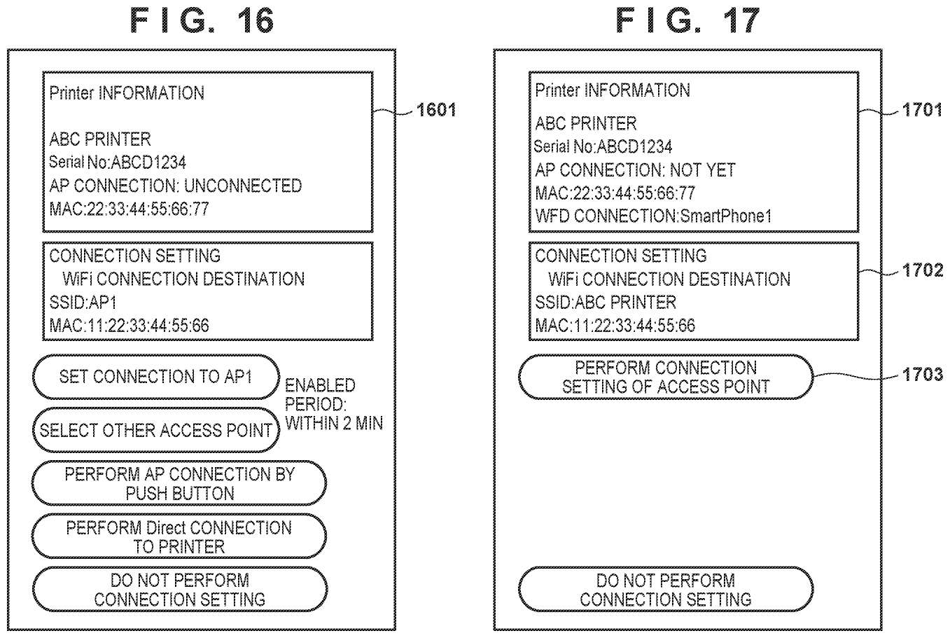

After that, the NFC unit of the information processing apparatus 101 comes close to the NFC unit of the communication apparatus 151, and data transmission in S107 and S108 of FIG. 3A is performed. Then, the state information of the communication apparatus 151 transmitted from the communication apparatus 151 to the information processing apparatus 101 is “first setting method: possible, second setting method: possible, third setting method: enabled, fourth setting method: possible”. In S110, a selection screen shown in FIG. 16 is displayed on the information processing apparatus 101. As shown in FIG. 16, the same selection items as in FIG. 4 are displayed on the selection screen. In the screen shown in FIG. 16, the connection state to an external access point in a region 1601 is “unconnected”, unlike the screen shown in FIG. 14.

A case where the information processing apparatus 101 is already connected to the communication apparatus 151 by WiFi Direct will be described next.

The information processing apparatus 101 performs the processes of S104 to S107 in FIG. 3A. In S108, the information of the communication apparatus 151 is transmitted as a Read response from the communication apparatus 151 to the information processing apparatus 101. Since the communication apparatus 151 is currently connected to the information processing apparatus 101 by WiFi Direct, the state information of the communication apparatus 151 is “first setting method: impossible, second setting method: impossible, third setting method: enabled, fourth setting method: impossible”. In this case, in S110, a screen shown in FIG. 17 is displayed on the information processing apparatus 101. In this case, since the communication apparatus 151 is connected to the information processing apparatus 101 by WiFi Direct, as shown in FIG. 17, items corresponding to the selection items 403, 404, 406, and 407 in FIG. 4 are not displayed. Also, in a region 1701, the information of the information processing apparatus 101 connected by WiFi Direct is displayed, like “WFD connection: SmartPhone1”. In a region 1702, the information of the communication apparatus 151 connected by WiFi Direct is displayed as the current WiFi connection destination. Also, a selection item 1703 used to connect the communication apparatus 151 to the access point A is displayed.

Here, if the selection item 1703 is selected, in S114, information corresponding to the selection item is transmitted as a Write request to the communication apparatus 151. Also, if the selection item 1703 is selected, the screen shown in FIG. 15, which urges the user to do a predetermined operation of the communication apparatus 151, is displayed on the information processing apparatus 101. When the screen shown in FIG. 15 is displayed, a warning message “connection to the printer currently connected in the direct mode is disconnected” may be displayed. If the user performs the predetermined operation, the communication apparatus 151 disconnects the connection to the information processing apparatus 101 by WiFi Direct and transitions to the network setup mode.

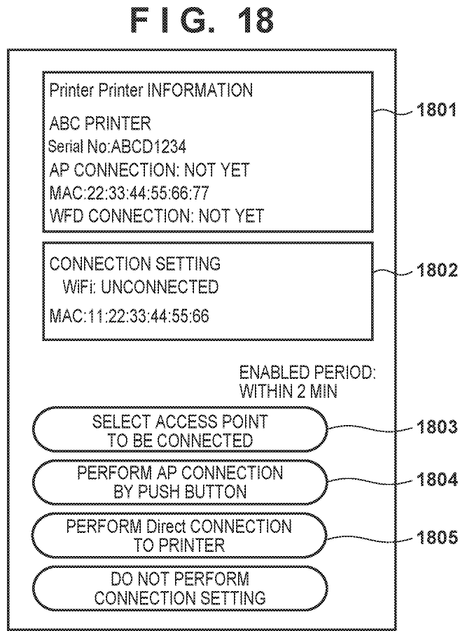

After that, the NFC unit of the information processing apparatus 101 comes close to the NFC unit of the communication apparatus 151, and data transmission in S107 and S108 of FIG. 3A is performed. Then, the state information of the communication apparatus 151 transmitted from the communication apparatus 151 to the information processing apparatus 101 is “first setting method: possible, second setting method: possible, third setting method: enabled, fourth setting method: possible”. In this case, in S110, a screen shown in FIG. 18 is displayed on the information processing apparatus 101. As shown in FIG. 18, the same selection items as the selection items 406 and 407 in FIG. 4 are displayed on the selection screen, but an item corresponding to the selection item 403 in FIG. 4 is not displayed. This is because an external access point to which the information processing apparatus 101 is currently connected does not exist. In the screen shown in FIG. 18, a region 1801 indicates “WFD connection: unconnected”, and a region 1802 indicates “WiFi: unconnected”, unlike the screen shown in FIG. 17. If a selection item 1803 is selected, the OS is requested to search for an external access point, and an AP search is performed. After the AP search, if the user selects an external access point, the same processing as in a case where the selection item 404 shown in FIG. 4 is selected is performed.

As described above, in other cases as well, it is possible to display, on the information processing apparatus 101, a selection screen on which a plurality of setting methods of network setup processing can be selected. In addition, since the user never performs screen operations on the communication apparatus 151, convenience can be improved.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2022-075411, filed Apr. 28, 2022, which is hereby incorporated by reference herein in its entirety.

What is claimed is:

1. A method comprising:
acquiring information of a communication apparatus from the communication apparatus capable of wirelessly communicating with an information processing apparatus;
displaying, on a display unit, a selection screen for a setting concerning connection between the communication apparatus and a device outside the communication apparatus, based on the acquired information of the communication apparatus; and
performing processing according to a selection result on the selection screen,
wherein the selection screen is a screen on which a plurality of connection methods for the setting are selectably displayed, and
the plurality of connection methods include a first connection method for connecting an access point outside the communication apparatus to the communication apparatus, and a second connection method for connecting, without the access point, the information processing apparatus to the communication apparatus.

2. The method according to claim 1, further comprising acquiring information of the information processing apparatus,
wherein the selection screen is displayed based on the acquired information of the communication apparatus and the acquired information of the information processing apparatus.

3. The method according to claim 2, wherein the information of the communication apparatus and the information of the information processing apparatus include an enable/disable state of execution of each of the plurality of connection methods.

4. The method according to claim 2, wherein the information of the information processing apparatus includes version information of an operating system.

5. The method according to claim 3, further comprising extracting a connection method executable by the communication apparatus and the information processing apparatus based on the acquired information of the communication apparatus and the acquired information of the information processing apparatus.

6. The method according to claim 5, wherein the acquired connection method is selectably displayed on the selection screen.

7. The method according to claim 5, wherein the first connection method includes a method of performing communication between the information processing apparatus and the communication apparatus using a first protocol as communication for connecting the access point and the communication apparatus, and a method of performing communication between the information processing apparatus and the communication apparatus using a second protocol different from the first protocol as the communication for connecting the access point and the communication apparatus.

8. The method according to claim 7, wherein the second protocol is Device Provisioning Protocol (DPP).

9. The method according to claim 7, wherein if both the method of performing the communication between the information processing apparatus and the communication apparatus using the first protocol and the method of performing the communication between the information processing apparatus and the communication apparatus using the second protocol are extracted as the connection methods executable by the communication apparatus and the information processing apparatus,
the method of performing the communication between the information processing apparatus and the communication apparatus using the first protocol is not displayed on the selection screen, and the method of performing the communication between the information processing apparatus and the communication apparatus using the second protocol is displayed on the selection screen.

10. The method according to claim 7, wherein if the first connection method is selected on the selection screen, the communication between the communication apparatus and the information processing apparatus by the second protocol is started.

11. The method according to claim 10, wherein if the second connection method is selected on the selection screen, the communication between the communication apparatus and the information processing apparatus by a third protocol different from the first protocol and the second protocol is started.

12. The method according to claim 11, wherein the third protocol is WiFi Direct.

13. The method according to claim 1, wherein the information of the communication apparatus is acquired from the communication apparatus by short distance wireless communication.

14. The method according to claim 13, further comprising a selection result on the selection screen is transmitted to the communication apparatus by short distance wireless communication.

15. The method according to claim 14, wherein
after selection is performed on the selection screen, a screen that urges a user to bring the information processing apparatus close to the communication apparatus is displayed on the display unit, and
when the information processing apparatus comes close to the communication apparatus, the selection result on the selection screen is transmitted to the communication apparatus.

16. The method according to claim 13, wherein
the short distance wireless communication is Near Field Communication (NFC).

17. An information processing apparatus comprising:
an acquisition unit configured to acquire information of a communication apparatus from the communication apparatus capable of wirelessly communicating with the information processing apparatus;
a display unit configured to display, on a display unit, a selection screen for a setting concerning connection between the communication apparatus and a device outside the communication apparatus, based on the information of the communication apparatus acquired by the acquisition unit; and
a processing unit configured to perform processing according to a selection result on the selection screen,
wherein the selection screen is a screen on which a plurality of connection methods for the setting are selectably displayed, and
the plurality of connection methods include a first connection method for connecting an access point outside the communication apparatus to the communication apparatus, and a second connection method for connecting, without the access point, the information processing apparatus to the communication apparatus.

18. A non-transitory computer-readable storage medium storing a program configured to cause a computer to function to:
acquire information of a communication apparatus from the communication apparatus capable of wirelessly communicating with an information processing apparatus;
display, on a display unit, a selection screen for a setting concerning connection between the communication apparatus and a device outside the communication apparatus, based on the acquired information of the communication apparatus; and
perform processing according to a selection result on the selection screen,
wherein the selection screen is a screen on which a plurality of connection methods for the setting are selectably displayed, and
the plurality of connection methods include a first connection method for connecting an access point outside the communication apparatus to the communication apparatus, and a second connection method for connecting, without the access point, the information processing apparatus to the communication apparatus.
